(19) United States
(12) Patent Application Publication
(10) Pub. No.: US 2011/0066563 A1
(43) Pub. Date: Mar. 17, 2011

(54) Mashup sevices and methods with quality of sevice (QoS) support

(76) Inventors: Lalita Jagadeesan, Naperville, IL (US); Veena Mendiratta, Oak Brook, IL (US)

(21) Appl. No.: 12/585,312

(22) Filed: Sep. 11, 2009

(51) Int. Cl. G06Q 10/00; H04B 1/40; H04M 11/00; G06N 5/02; G06Q 50/00

(52) U.S. Cl. 705/317; 455/88; 455/405; 706/52

(57) ABSTRACT

Mashup hosts to integrate services and/or data into a single integrated application, the services include one or more quality of service specifications (QoS). Service servers to receive service requests, the service requests including one or more quality of service specifications and to generate and transmit a service based on data, executable code and the quality of service specifications. The QoS parameters may include probabilistic real-time automata and temporal logic service QoS parameters.

### BACKGROUND OF THE INVENTION

Embodiments relate to mashup technologies enabling the rapid creation of sophisticated web-based services incorporating rich content, social networking, and other capabilities.

A mashup typically integrates data and functionality from two or more disparate sources into a single integrated application, resulting in a new and distinct web service not originally provided by either of the sources. For example, some mashups integrate a map service with real-estate data to provide location information on available housing.

A hallmark of mashups is that they are composed quickly through open APIs and data sources, using standard web paradigms. Recently, telecommunication service providers and Internet telephony providers have deliberately exposed their telecommunication capabilities for use in voice communication mashups. As these APIs are geared towards web developers and do not require knowledge of specialized telecommunications protocols and standards, mashups are increasingly incorporating telecommunication capabilities into the services they provide

### SUMMARY OF THE INVENTION

One embodiment includes a first transceiver configured to transmit and receive data packets to and from a communication network and a second transceiver configured to transmit data to and from service providers. The embodiment further includes a processor (CPU) configured to request services via the second transceiver from two or more service providers, the requested services including one or more quality of service specifications. The processor (CPU) is configured to receive services, influenced by the one or more quality of service specifications, from the service providers via the second transceiver. The processor (CPU) is configured to integrate the influenced services into a single integrated application, and to transmit the single integrated application to a user via the first transceiver.

One embodiment includes a transceiver configured to transmit and receive data. The embodiment includes a processor (CPU) configured to receive a service request from a requestor via the transceiver, the service request including one or more quality of service specifications. The processor (CPU) is configured to generate the service based on the quality of service specifications and to transmit the service to the requestor via the transceiver.

One embodiment of a method includes requesting, from one or more servers, two or more services the request includes one or more quality of service specifications. The method further includes receiving the services influenced by the quality of service specifications from the servers and integrating the influenced services into a single integrated application as well as transmitting the single integrated application to a requesting user.

One embodiment of a method includes receiving a service request, the request including one or more quality of service specifications. The method further includes generating an influenced service based on the quality of service specifications and transmitting the influenced service.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a network to communicate voice communication mashups within telecommunication service provider networks or within the public internet according to an example embodiment.

FIG. 2 illustrates a mashup host according to example embodiments.

FIG. 3 illustrates a service server according to example embodiments.

FIG. 4 illustrates a network to communicate voice communication mashups within telecommunication service provider networks or within the public internet according to an example embodiment.

FIG. 5 illustrates a communication flow diagram of a mashup service request according to example embodiments.

FIG. 6 illustrates a method of operation of a service server according to an example embodiment.

FIG. 7 illustrates a method of operation of a mashup host according to an example embodiment of a mashup service using state indicators.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

A server or a host may be a mashup server or a mashup host and/or a web server or a web host. A service may be a component service and/or a web service. The service may be configured to be combined with another service to create a new service, new application or mashup.

Example embodiments are directed to a framework for formal specification of voice communication mashup Quality of Service (QoS) based on probabilistic real-time automata and temporal logic in which QoS specifications of voice communication mashups may be recursively composed from the QoS specifications of their underlying services. This framework is compatible with the emerging standards and Web 2.0 technologies.

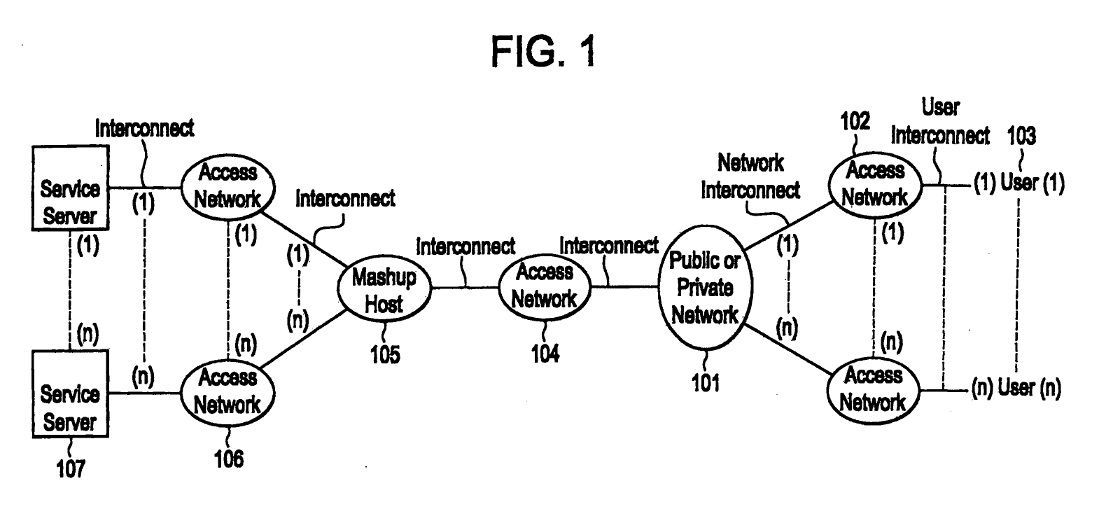

FIG. 1 illustrates an example embodiment of a network configured to communicate integrated mashup applications/services. A user 103 is connected to a public or private network 101 via an access network 102. The user 103 may be using a web browser on, for example, a computer or a cell phone. In addition, the user may be using standard voice services, for example a cell phone or a telephone.

The access network 102 may be any network configured to connect a user 103 to a public or private network 101. The access network 102 may be, for example, a cellular phone network, a public switched telephone network (PSTN), or an Internet Protocol (IP) based network.

The public or private network 101 may be, for example, a public Internet, e.g., the World Wide Web (WWW), or a private intranet. The public or private network 101 is connected to a mashup host 105 via an access network 104. The access network 104 is the same as access network 102 except it is configured to connect the public or private network 101 to the mashup host 105. Each network element in FIG. 1 may be interconnected via network interconnects that may be wired or wireless.

The mashup host 105 may be configured to communicate with two or more service servers 107 via an access network 106. The access network 106 is the same as access network 102 except it is configured to connect the mashup host 105 with two or more service servers 107.

The service servers 107 may provide voice services or web services. Voice services may be services configured to expose telecommunication capabilities of a telecommunication network to the mashup host 105 via an interface of the private or public network 101. In other words the voice service may be configured to allow the mashup host to execute computer executable code on the service server, the code representing the voice service.

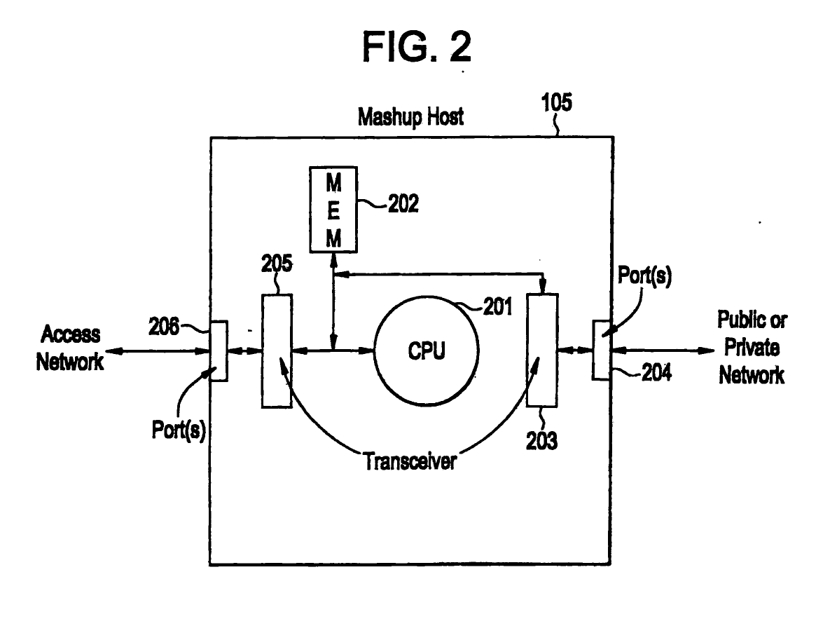

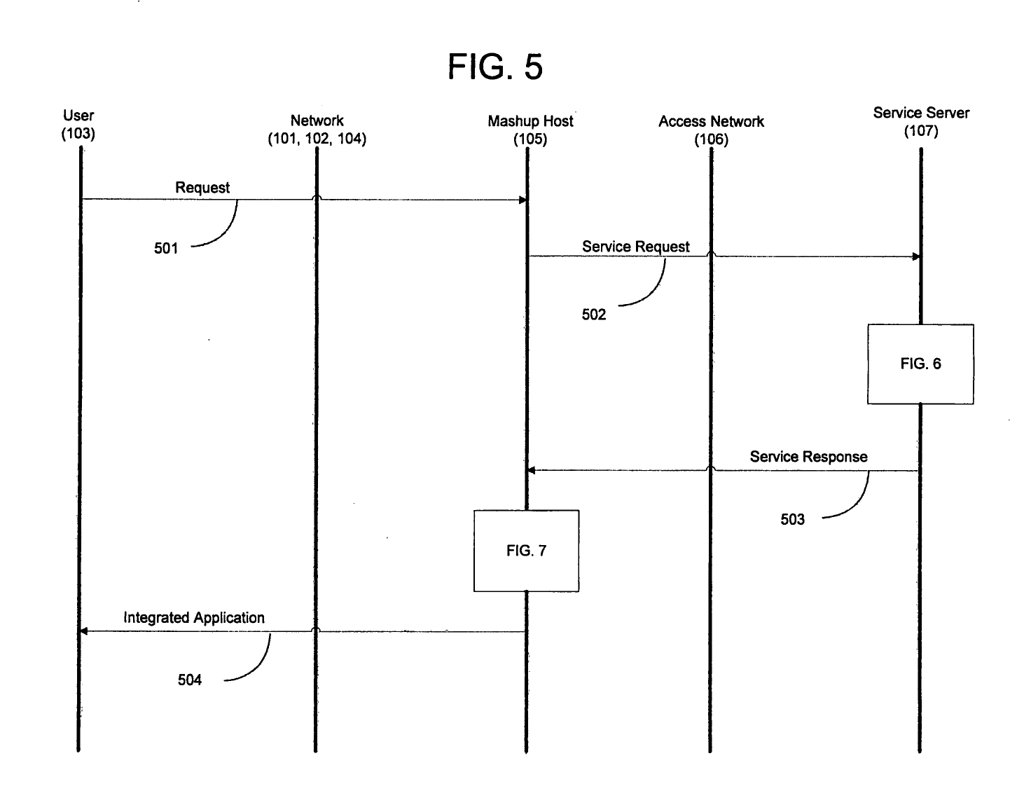

FIG. 2 illustrates the mashup host 105 referred to in FIG. 1, according to an example embodiment. The mashup host 105 is a network element configured to, at least, integrate data and functionality from two or more disparate sources into a single integrated application, resulting in a new and distinct web service not originally provided by either of the two or more disparate sources. The mashup host 105 may be a standalone hardware component or be part of another network element. The operation of the mashup host 105 will be described in more detail while describing FIG. 5 below.

The mashup host 105 may include a CPU 201, a memory 202, transceivers 203, 205 and ports 204, 206. The integration of the services into a single application may be accomplished through, but is not limited to, a software application stored in the memory 202 and executed by the CPU 201.

Transceiver 203 may be configured to transmit and receive data to and from a public or private communication network. Transceiver 205 may be configured to transmit data to two or more service providers and receive data from the service providers.

CPU 201 may be configured to request services via transceiver 203. The service requests may include one or more QoS specifications. The QoS specifications may be Service Level Agreements (SLAs) quantifying event response time delays and failure levels allowed by services. QoS specifications and SLAs will be described in more detail below.

CPU 201 may be configured to integrate the received services, which were influenced by the QoS specifications, into a single integrated application and transmit the single integrated application to a user via transceiver 203. A user may be an end user or another mashup host.

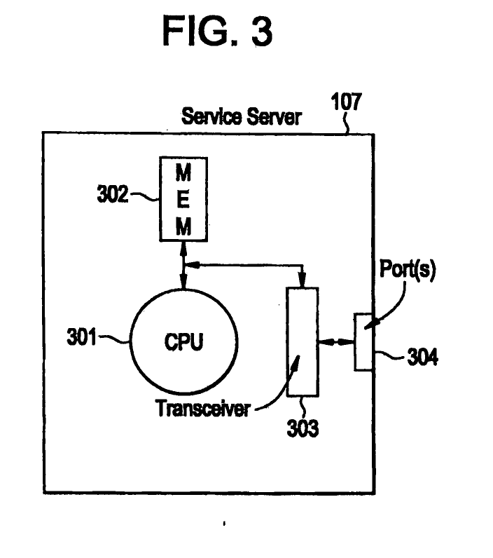

FIG. 3 illustrates the service server 107 referred to in FIG. 1, according to an example embodiment. The service server 107 may be a standalone hardware component or be part of another network element. The operation of the service server 107 will be described in more detail below while describing FIG. 5.

The service server 107 may include a CPU 301, a memory 302, a transceiver 303, and a port 304. The delivery of a service may be accomplished through, but is not limited to, a software application stored in the memory 302 and executed by the CPU 301.

Transceiver 303 may be configured to receive data and transmit data. Memory 302 may be configured to store data and computer executable code forming a service.

CPU 301 may be configured to receive a service request. The service request may include one or more QoS specifications. The QoS specifications may be Service Level Agreements (SLA) quantifying event response time delays and failure levels allowed by services. QoS specifications and SLAs will be described in more detail below. CPU 301 may be configured to generate the service based on the data, computer executable code and the QoS specifications. CPU 301 may also be configured to transmit the service, which was influenced by the QoS specifications, to a requestor via the transceiver 303.

The service server 107 may provide voice services or web services. Voice services may be services configured to expose telecommunication capabilities of a telecommunication network to a requestor via an interface of the private or public network 101. In other words, the voice service may be configured to allow a remote host, e.g. mashup host 105, to execute computer executable code resident on the service server 105, the code representing the voice service.

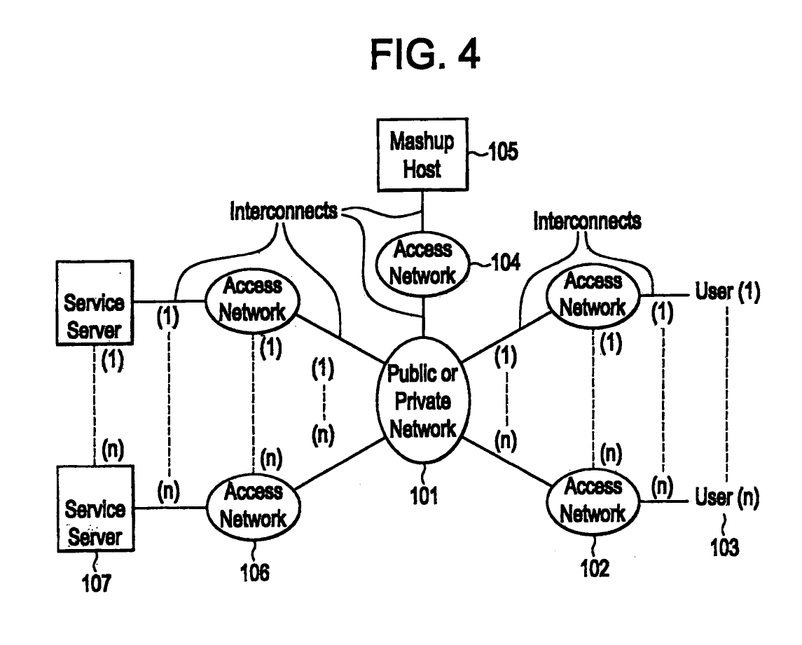

FIG. 4 illustrates another example embodiment of a network configured to communicate integrated mashup applications/services. This network is the same as the network described with respect to FIG. 1, except that the mashup host 105 communicates with the service servers 107 via the public or private network 101.

FIG. 5 illustrates a communication flow diagram showing the sequence of events from the initiation of a request by a user 103 of a service served by a mashup host 105 to the reception of the service by the user 103. In describing the sequence of events with regard to FIG. 5, the operation of each apparatus described in FIGS. 1-3 will be described in more detail.

Throughout the description of FIG. 5, an exemplary mashup will be used to more clearly illustrate the example embodiment. The exemplary mashup is an example of a voice communication mashup aimed at the health-care industry. The exemplary mashup enables patients to communicate with nurses and doctors via Interactive Voice Response (IVR) services and via Short Message Service (SMS) text messages. The purpose of the exemplary mashup is to allow patients and health care workers to communicate during off hours and therefore the mashup is known as an “after hours doctors' office” service.

A user 103 sends a request 501 for a service that may be a mashup service. A user may be using a web browser on, for example, a computer or a cell phone. In addition, the user may be using standard voice services, for example a cell phone or a telephone. A user may be an end user of the mashup or may also be another mashup host. A user may use the service or act as a conduit to transfer the service to a secondary user.

For example, a patient dials into the phone number for an after hours doctors' office service.

The request 501 is transmitted through the network 101, 102, 104 to a mashup host 105. The request 501 may include data representing, for example, the user, the type of request, user location, the system the user is using, etc. If the user is using an analog system, e.g., a telephone, the network may digitize and packetize the analog data.

For example, the phone call triggers the request for the After Hours Doctors' Office mashup.

In response to the request, the mashup host 105 will generate the requested mashup. The mashup host 105 sends a request for two or more services from one or more service servers 107. The transceiver 205 sends the requests to the one or more service servers 107. The CPU 201 is configured to generate the requests based on inputs, for example, including parameters, data, code segments, user input data, etc. Some of the inputs may be stored in memory 202, or may be externally generated, for example from the user request.

For example, the services may include an IVR service to answer the phone call and a nursing bank service to evaluate the patient's condition.

The service requests may include one or more quality of service (QoS) specifications. The QoS specifications may be Service Level Agreements (SLA), described in more detail below, quantifying event response time delays and failure levels allowed by services. A SLA may be based on probabilistic real-time automata and probabilistic real-time temporal logic, each of which is described in more detail below. The probabilistic real-time temporal logic specification may have one or more associated probabilities of failure level and one or more associated delay time parameters.

The generated service requests 502 may be transmitted to the one or more service servers 107 via access network 106. Service servers 107 generate service responses 503 and the generated service responses 503 may be transmitted to the mashup host via access network 106.

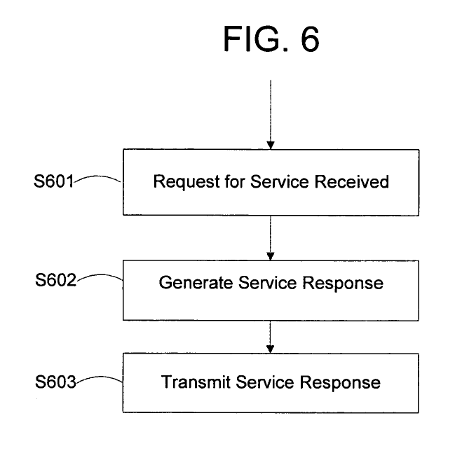

The operation of the service server 107 will now be described in more detail while referring to FIG. 3 and FIG. 6. In step S601 a request for a service is received by a service server 107. Transceiver 303 may be configured to receive data associated with the request. The CPU 301 may receive the request and this may trigger some action by the CPU 301.

The request may include one or more quality service (QoS) specifications. The QoS specifications may be Service Level Agreements (SLAs) quantifying event response time delays and failure levels allowed by services. QoS specifications and SLAs will be described in more detail below

In step S602 the CPU 301 generates the mashup service using inputs that may include, for example data and computer executable code segments stored in memory 302, the QoS specifications and/or other data inputs. The other data inputs may be stored in memory 302, or be externally generated, for example from the service request.

For example, the IVR system may begin by answering the phone call. The patient may be asked to leave a voice mail about his health condition. In addition, the patient may be asked to leave his phone number and to indicate whether he is on a mobile phone or a landline. The generated service response may be the voice message, and/or a textual transcription of the voice message. The service response may be influenced by QoS specifications.

The mashup host may then use the service response, which may be influenced by QoS specifications, from the IVR system, the voice message and/or the text, as data to be sent to the nursing bank service. The nursing bank service may include several functions and/or service responses each of which may be influenced by QoS specifications. A nurse working for the nursing bank may, for example, notify the patient that his voice mail has been received, evaluate the condition of the patient based on the voice mail, contact the patient informing him of the evaluation and/or contact a doctor if the condition is serious.

Although this example describes a sequential relationship between the services, the example embodiments are not limited thereto.

Generating the service response in step S602 may be accomplished through execution of a state machine having code and/or event states. Code (event) states, may have a time limit/delay for completing execution based on, for example, a QoS parameter. Code (event) states may have a probability of failure based on, for example, a QoS parameter. As will be appreciated the state machine and the level of influence the QoS specifications have on the state machine are a matter of design choice by a service provider.

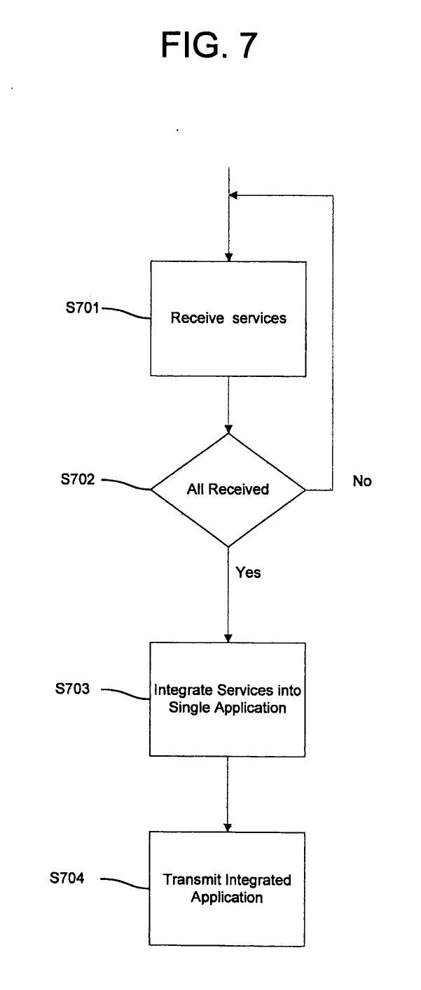

For the IVR service and the nursing bank service discussed previously the QoS parameters shown in Table 1 and Table 2 may be used by the state machine at a service server. Note that these probabilities and time constraints are exemplary only, and that the actual values would depend on the application and the provider. The values may be variables associated with steps and described in FIG. 7.

TABLE 1

| Example QoS | |
|---|---|
| Parameter | IVR service |
| 1 | The maximum time bound for a voice mail is 2 |
| | minutes |
| 2 | With probability p1, a voice mail left by the caller |
| | must be forwarded (e.g. sent to the on-demand nurses |
| | workforce) within 1 minute |
| 3 | With probability p2, a nurse must send an |
| | acknowledgment SMS (e.g. a second request to the |
| | IVR service by the mashup host) to the patient within |
| | 1 minute of the patient's voice mail being sent to the |
| | nurse workforce |

TABLE 2

| Example QoS | |
|---|---|
| Parameter | On-demand nurse workforce SLA |
| 1 | With probability p3, a nurse must send an |
| | acknowledgment SMS to the patient within 1 minute |
| | of the patient's voice mail being sent to the nurse |
| | workforce |
| 2 | A SMS advising the patient must be sent by a nurse |
| | within 8 minutes of the nurse sending the initial |
| | acknowledgement. If the patient's condition is deemed |
| | by the nurse to be potentially serious, a doctor must |
| | contact the patient within 10 minutes following the |
| | nurse's SMS |

Returning to FIG. 6, in step S603 the transceiver 303 may transmit the generated service response (the mashup service) influenced by the QoS specifications from the service server 107 to the requestor.

For example, the voice message or the nurses advice to the patient.

Returning to FIG. 5, the influenced service response 503 is transmitted to the mashup host 105 from the mashup server 107 via access network 106.

FIG. 7 illustrates a method of operation of a mashup host. As shown in FIG. 2 and FIG. 7, in step S701 transceiver 205 may receive data associated with the service responses influenced by the QoS specifications. In step S702, the CPU 201 may check to see if any of the requested service responses have not been received. The CPU 201 may count the number of received service responses, and if the number of received responses is less than the number of requested services all of the requested services have not been received. If there are service responses remaining to be received, step S701 is repeated and the CPU 201 continues to receive the services influenced by the QoS specifications via the transceiver 205.

If there are no services influenced by the QoS specifications remaining to be received, step S703 is performed by the CPU 210 in order to integrate the services influenced by the QoS specifications into a single integrated application. Integration may be performed by the CPU 210 based on inputs, for example, including parameters, data, code segments, and/or user input data. In addition, the CPU 210 may use the data or code segments returned, as part of the service response, from the service server 107 as inputs to the integration of step S703. Some of the inputs may be stored in memory 202, or be externally generated, for example from the user request or the service response.

The inputs stored in memory 202 may be responses from prior service requests. The CPU 210 may integrate service requests/responses made in parallel (e.g. all requests are independent of each other). The CPU 210 may integrate service requests/responses made sequentially (e.g. the response from a first service request may be used as an input to a second service request).

The CPU 210 configures the integrated application such that the application may be sent over a network and received by a user using a known protocol. In step S704 the CPU sends the integrated application to transceiver 203. Transceiver 203 transmits the application to the requesting user 103 via the access server network102.

For example, the CPU 210 may configure the nurse's advice response so that the response can be sent to a telecommunications service, which in turn sends an SMS message, including the advice, to the patients' cell phone. The CPU 210 may configure the nurse's advice response so that the response can be sent to a telecommunications voice service, which in turn sends a voice message, including the advice, to the patients' cell phone.

Returning to FIG. 5, as described above the mashup host 105 transmits 504 the integrated application to the user 103 via the network 101, 102, 104.

Quality of Service (QoS) specifications according to example embodiments will now be discussed in more detail. Service users may need to have guarantees on the reliability and QoS of applications prior to their use. As mashups are inherently compositional, being created from two or more disparate sources of functionality and data, Service Level Agreements (SLA) may also be specified compositionally on the services comprising the mashup.

Probabilistic timed automata extend standard finite-state automata or state machines with real-time and probabilistic information. In other words, a finite-state automata is a state machine as is known in the art. A probabilistic timed automata is an advanced state machine that includes a time limitation for execution and a probability of executing successfully. As with standard finite-state automata, (probabilistic) timed automata may consist of states, together with transitions between states. The transitions may be labeled by actions corresponding to system behavior, e.g., a SMS was sent.

To specify real-time behavior, timed automata allow the specification of real-time clocks and guards. States may be annotated with real-time clocks and associated clock variables to represent the passage of time since entry into the state. Guards on transitions represent conditions under which a transition between states is enabled. Guards may have integer constraints, e.g., less than 2 minutes have passed since entry into a state.

Temporal logic as used in example embodiments may describe an action, e.g., execution of a state, within a limited time period. For example, assume the state to be executed is the answering of a phone call. Using temporal logic dictates that the call is to be answered within a certain period of time, e.g., within 10 seconds or within 5 rings.

Probabilistic real-time automata as used in example embodiments may describe the probability that flow moves on to another state; for example, using the above phone call example assume the call is answered. In addition, assume that the call may be answered by a person or a machine. If the probability that a person answers the phone is p, the probability that a machine answers is 1-p.

Service Level Agreements may be based on probabilistic real-time automata and probabilistic real-time temporal logic. The probabilistic real-time automata and the probabilistic real-time temporal logic specification may have one or more associated probabilities of failure level and one or more associated delay time parameters.

Specifying the QoS parameters for the above phone call example, may be as follows:

time to answer <5 rings

answered by human >95%

Should the call not be answered within 5 rings, the process returns to the initial state of the process, e.g., waiting for the next call. The remaining 5% of the calls are answered by a machine.

Architectural choices may need to be considered with respect to public and private communication networks to assess the QoS and reliability of mashups. For example, QoS and reliability of private communication networks may be higher than the public Internet. In particular, the public internet cannot guarantee QoS, as it is best effort only (and message sending can be delayed, can fail or timeout). However, a best effort by the communication network including the public internet may continue to provide services influenced by QoS specifications. The expected QoS and reliability of the component elements may vary if hosted independently versus all being on a single entity. Regardless of whether service elements are hosted independently or on a single entity, the services may be influenced by QoS specifications.

Referring to FIG. 1 and FIG. 4, the architecture of FIG. 1 may be more reliable than the architecture of FIG. 4. In FIG. 1, the mashup host 105, access network 106 and service server 107 are configured such that they may be part of a private network. Whereas the network of FIG. 4 may require transmission of service requests and responses through a public Internet with a lower reliability for the reasons described above.

While example embodiments have been particularly shown and described, it will be understood by one of ordinary skill in the art that variations in form and detail may be made therein without departing from the spirit and scope of the claims.

The invention being thus described, it will be obvious that the same may be varied in many ways. Such variations are not to be regarded as a departure from the invention, and all such modifications are intended to be included within the scope of the invention.

We claim:

1. An apparatus, comprising:
a first transceiver configured to transmit and receive data to and from a communication network;
a second transceiver configured to transmit and receive data to and from service providers;
a processor configured to request services via the second transceiver from two or more service providers, the requested services including one or more quality of service specifications, the processor configured to receive services influenced by the one or more quality of service specifications from the service providers via the second transceiver, the processor configured to integrate the influenced services into a single integrated application, and the processor configured to transmit the single integrated application to a user via the first transceiver.

2. The apparatus of claim 1, wherein the processor is configured to request a voice service as one of the requested services, the voice service allowing a remote execution of a computer executable code representing the voice service.

3. The apparatus of claim 1, wherein the processor is configured to request a web service as one of the requested services.

4. The apparatus of claim 1, wherein the communication network is one of a private network and a public network.

5. The apparatus of claim 1, wherein the one or more quality of service specifications are Service Level Agreements that quantify the event response time delays and failure levels allowed by the requested services.

6. The apparatus of claim 5, wherein the Service Level Agreements are based on at least one of probabilistic real-time automata and probabilistic real-time temporal logic, the probabilistic real-time automata and the probabilistic real-time temporal logic specification each having one or more associated probabilities of failure level and one or more associated delay time parameters.

7. The apparatus of claim 6, wherein the processor is configured to request from at least one of the service providers a service including a plurality of execution states, each of the plurality of execution states includes the one or more quality of service specifications as an associated probability of failure level parameter and delay time parameter.

8. An apparatus, comprising:
a transceiver configured to transmit and receive data; and
a processor configured to receive a service request from a requestor via the transceiver, the service request including one or more quality of service specifications, the processor configured to generate the service based on the quality of service specifications, and the processor configured to transmit the service, influenced by the quality of service specifications, to the requestor via the transceiver.

9. The apparatus of claim 8, wherein the processor is configured to request a voice service as one of the requested services, the voice service allowing a remote execution of computer executable code representing the voice service.

10. The apparatus of claim 8, wherein the one or more quality of service specifications are Service Level Agreements that quantify the event response time delays and failure levels allowed by the requested services.

11. The apparatus of claim 10, wherein the Service Level Agreements are based on at least one of probabilistic real-time automata and probabilistic real-time temporal logic, the probabilistic real-time automata and the probabilistic real-time temporal logic specification each having one or more associated probabilities of failure level and one or more associated delay time parameters.

12. The apparatus of claim 11, wherein the processor is configured to generate the influenced service based on a plurality of execution states, each of the plurality of execution states includes the one or more quality of service specifications as an associated probability of failure level parameter and delay time parameter.

13. A method, comprising:
requesting, by a host, two or more services from one or more servers, the request including one or more quality of service specifications;
receiving, by the host, services influenced by the quality of service specifications from the servers;
integrating, by the host, the influenced services into a single integrated application; and
transmitting, by the host, the single integrated application to a requesting user.

14. The method of claim 13, wherein requesting the two or more services includes requesting at least one of the services as a voice service, the voice service allowing the requestor to remotely execute a computer executable code representing the voice service.

15. The method of claim 13, wherein the one or more quality of service specifications are Service Level Agreements that quantify the event response time delays and failure levels allowed by the requested services.

16. The method of claim 15, wherein the Service Level Agreements are based on at least one of a probabilistic real-time automata and a probabilistic real-time temporal logic, the probabilistic real-time automata and the probabilistic real-time temporal logic specification each having one or more associated probabilities of failure level and one or more associated delay time parameters.

17. A method, comprising:
receiving, by a service server, a service request, the service request including one or more quality of service specifications;
generating, by the service server, an influenced service based on the quality of service specifications; and
transmitting the influenced service.

18. The method of claim 17, wherein the influenced service is a voice service, the voice service allowing remote execution of a computer executable code representing the voice service.

19. The method of claim 17, wherein the one or more quality of service specifications are Service Level Agreements that quantify one or more event response time delays and one or more failure levels allowed by the requested services.

20. The method of claim 19, wherein the Service Level Agreements are based on at least one of a probabilistic real-time automata and a probabilistic real-time temporal logic, the probabilistic real-time automata and the probabilistic real-time temporal logic specification each having one or more associated probabilities of failure level and one or more associated delay time parameters.
